(19) United States
(12) Patent Application Publication
(10) Pub. No.: US 2011/0283519 A1
(43) Pub. Date: Nov. 24, 2011

(54) DEVICE TO CONVERT A CLUTCH PURSE TO A STRAP PURSE

(76) Inventor: Holly Pranger, San Francisco, CA (US)

(21) Appl. No.: 13/110,450

(22) Filed: May 18, 2011

Related U.S. Application Data
(60) Provisional application No. 61/345,898, filed on May 18, 2010.

(51) Int. Cl. B23P 17/04; B23P 19/00

(52) U.S. Cl. 29/525.01; 29/700

(57) ABSTRACT

In the preferred embodiments, the device includes a rod, a strap whose two ends are attached to the ends of the rod, and an apparatus for affixing the rod to a clutch bag, thereby converting the bag to one with a strap. In a first variation, the rod is equipped with clips that are adapted to clip onto the bag, holding the rod, for instance, under a flap of the bag. In a second variation, the rod includes two telescoping sections, and the device includes a compression spring which biases the two sections of the rod away from each other. This arrangement may allow the rod to be placed inside the bag with its two ends in compression between opposing interior surfaces of the bag, thereby holding it in a fixed position relative to the bag.

### CROSS-REFERENCE TO RELATED APPLICATIONS

This application claims the benefit of U.S. Provisional Application No. 61/345,898 filed 18 May 2010 and entitled “Device to Convert a Clutch Purse to a Strap Purse,” which is incorporated in its entirety by this reference.

### BACKGROUND

The clutch purse and the strap purse are two commonly available purse types. A strap purse includes a strap that allows the purse to be hung on the shoulder of the user, a hook, or a chair, while a clutch purse is designed to be held in the hand or under the arm of the user. In certain usage scenarios, a clutch purse may be less convenient than a strap purse because the clutch purse cannot be hung onto something. While some clutch purses are designed by the manufacturer to include a strap attachment that allows for the clutch purse to be converted into a strap purse, many clutches do not include a strap attachment or any means for attaching a strap.

Another problem is that a strap of a purse concentrates the support of the weight of a purse to the attachment points of the strap. When a purse is hung from a point central to the attachment points of the strap (for example, on the shoulder of the user or a hook), the weight of the purse pulls the attachment points of the strap towards each other. Because most clutch purses are designed to be held in the hand or under the arm of the user, clutch purses, even ones designed to include a strap attachment, are not designed with the structural support necessary to prevent the attachment points of the strap from being pulled together, thus warping the form of the purse.

Thus, there is a need for a device that converts a clutch purse to a strap purse while maintaining the form of the clutch purse. This invention provides such a device.

### BRIEF DESCRIPTION OF THE FIGURES

FIG. 1 is an illustration of the purse conversion device of the preferred embodiments.

FIG. 2 is an illustration of the purse conversion device of the preferred embodiments integrated into a clutch.

FIGS. 3a and 3b are illustrations of the strap attachment of a first and a second variation, respectively.

FIGS. 4a and 4b are illustrations of the purse conversion device including an extender integrated into a snap clasp type clutch in the open position and the closed position, respectively.

FIG. 5 is an illustration of a base of the purse conversion device of adjustable length.

FIG. 6 is an illustration of a variation of the base of adjustable length.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

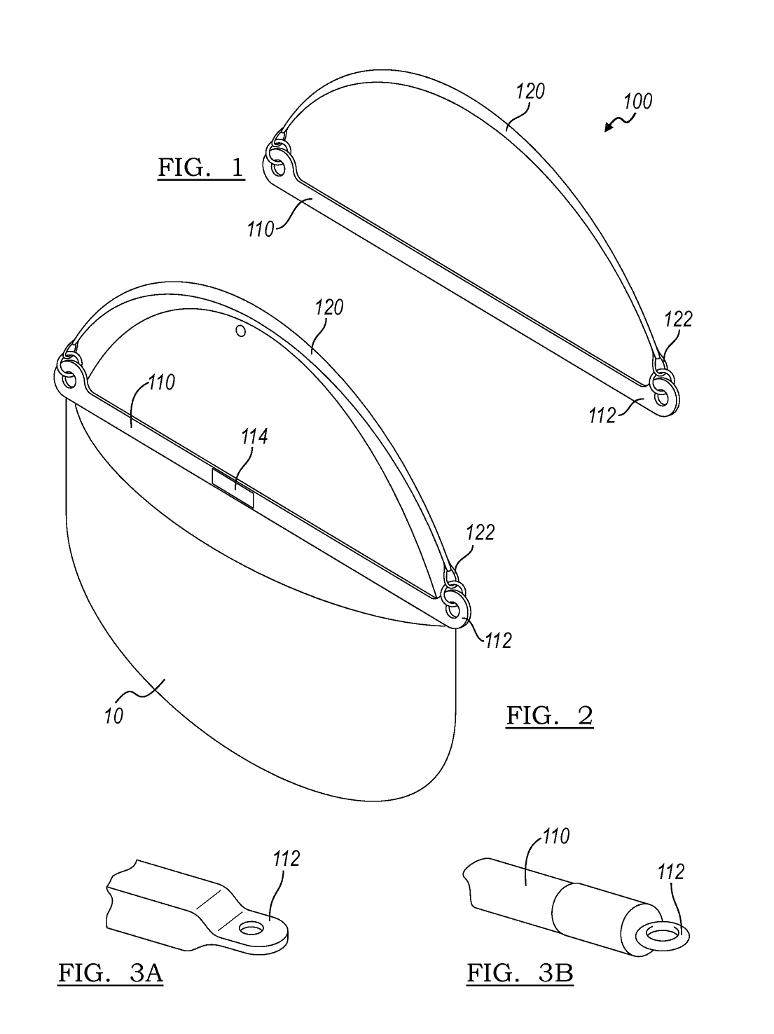

As shown in FIG. 1, the purse conversion device 100 of the preferred embodiments includes a rod 110, also referred to as a base, and a strap 120. The base 110 preferably includes a strap attachment 112 and the strap 120 preferably includes a base attachment 122. As shown in FIG. 2, the purse conversion device 100 is preferably applied to a clutch 10 and the base 110 is preferably arranged on an interior surface of the clutch 10 such that, when the clutch 10 is closed, the base 110 is hidden. The strap 120 remains on the exterior of the clutch 10, converting the clutch 10 into a strap purse, which can be hung on the shoulder of the user, a hook, a chair, or any other suitable object. As shown in FIG. 2, the base 110 may also include a fastener 114 that fastens the base 110 to an interior surface of the clutch 10. The fastener 114 is preferably non-permanent, but may alternatively be a permanent type of fastener 114.

The base 110 of the preferred embodiments functions to provide attachment points 112 for the strap 120. The base 110 is preferably substantially rigid. Because the strap 120 is attached to the base 110 and not directly to the clutch 10, the purse conversion device 100 provides the clutch 10 with structural support to prevent warping of the shape of the clutch 10 when converted into a strap purse. Preferably, the base 110 is of a metal material, such as aluminum, steel, copper, or any other suitable metal. Alternatively, the base 110 may also be of a substantially stiff plastic material, such as acrylic, polycarbonate, acrylonitrile butadiene styrene (ABS), or any other suitable plastic or combination of plastics. The base 110 may also be of a clear material (such as polycarbonate) to decrease the visibility of the base 110, but may alternatively be of any other suitable color to match the clutch 10. The base 110 may also include a colored sleeve that at least partially envelops the base 110 to match a clutch 10. The colored sleeve is preferably of a fabric material, but may alternatively be of any other suitable material. The base 110 is preferably of a substantially low profile rod geometry that extends across the length of the clutch 10 to decrease the visibility of the base 110 when coupled to the clutch 10. The low profile geometry of the base 110 may also decrease visible deformation of the outer surfaces of the clutch 10 resulting from the base 110. The rod may be of a circular cross section, rectangular cross section, a “D” cross section, or any other suitable type of cross section.

The strap attachment 112 of the preferred embodiments functions to provide the user with a point of attachment for the strap 120 to the base 110. The strap attachment 112 preferably includes two attachment portions located on either end of the base 110 that may protrude beyond the perimeter of the clutch 10. Each attachment portion preferably includes a bore or a ring that functions as the attachment point and allows the strap 110 to be coupled to the base 110. Each attachment portion may also include a hook to couple to the strap 110. The strap attachments 112 preferably have the same cross sectional profile as the base 110 and are preferably of the same continuous piece of material, but may alternatively be of a different material and/or cross section. For example, the material of the base 110 may be reduced to a smaller cross section or a different type of cross section at the ends to form the strap attachment 112, as shown in FIG. 3a, which may facilitate in decreasing the visibility of the strap attachment 112. In another example, the strap attachment 112 may be an aesthetic cap that attaches to either end of the base 110, as shown in FIG. 3b. The aesthetic cap may be of a color that suitably matches the color of the clutch 10 and may be selected from a variety of aesthetic caps of a variety of colors by the user. However, any other suitable arrangement may be used.

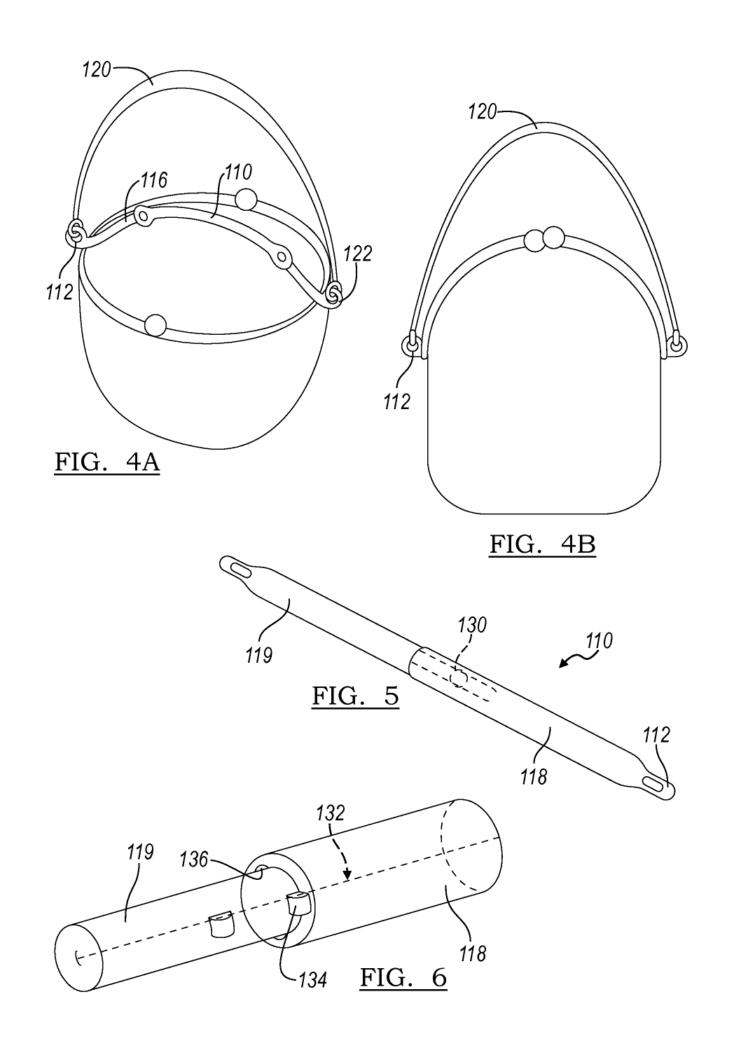

As shown in FIGS. 4a and 4b, the strap attachment 112 may also include an extender 116 that extends each attachment point away from either end of the base 110. This may be used where the base 110 cannot protrude outside the clutch 10 (in, for example, clutches 10 that include a snap clasp) and/or in any other suitable usage scenario. The extender 116 is preferably of a pliable material such as fabric or a thin plastic. When applied to a clutch 10 with a snap clasp, the extender 16 is preferably thin enough to pass through the snap clasp, while allowing the snap clasp to function normally (e.g. the snap clasp may be fastened).

The base 110 of the preferred embodiments also functions to accommodate a plurality of different sized clutch purses 10. As shown in FIG. 5, the base 110 preferably includes a first portion 118 and a second portion 119 that move relative to each other. In a first variation, the first and second portions 118 and 119 telescope relative to each other to adjust the overall length of the base 110. The first portion 118 at least partially envelopes the second portion 119 and the first and second portions 118 and 119 are friction fit to each other to maintain the relative positions between the two portions until a user applies force to adjust the length of the base 110. In this variation, the base 110 may also include a loosener that loosens the friction fit between the first and second portions to facilitate the user in adjusting the length of the base 110. For example, the loosener may push apart the surfaces of a first portion 118 that partially envelops the second portion 119 to loosen the friction fit.

In a second variation, the base 110 may include an adjustment fastener 130 that functions as a set screw that applies pressure to the second portion 119 to maintain the relative position between the portions. Alternatively, the second portion 119 may include bores and the adjustment fastener 130 may alternatively function to engage a bore in the second portion 119 to maintain the relative position between the portions. To align the first and second portions 118 and 119, the first portion 118 may at least partially envelop the second portion 119, or alternatively, the base 110 may include a second adjustment fastener 130 that engages a second bore on the second portion 119.

In a third variation, the first portion 118 may include a set of threads on an internal surface and the second portion 119 may include a set of mating threads on an external surface. When the second portion 119 is rotated relative to the first portion 118, the sets of thread cooperate to allow the portions to telescope relative to each other, adjusting the length of the base 110.

In a fourth variation, as shown in FIG. 6, the first portion 118 at least partially envelops the second portion 119 and the two portions are rotatable relative to each other. A spring couples the first portion 118 to the second portion 119 and provides a force to pull the second portion 119 farther into the first portion 118. The second portion 119 of this example preferably includes protrusions or pegs 134 substantially perpendicular to the surface of the second portion 119 and the first portion 118 includes peg clearances 136 that allow the pegs 134 to slide into and out of the first portion 118 at a first angle. When the second portion 119 is rotated to a second angle, the pegs 134 interface with the outer surface to prevent the spring from pulling the second portion 119 farther into the first portion 118.

In a fifth variation, the first portion 118 at least partially envelops the second portion 119. A spring couples the first portion 118 to the second portion 119 and provides an outward reaction force when the second portion 119 is pushed farther into the first portion 118. This may be used to couple the base 110 to the interior of the clutch 10 by placing the two ends of the base 110 between opposing surfaces of the interior of the clutch 10, with the spring in compression and biasing the first portion 118 and the second portion 119 away from each other, so as to hold the base 110 in a fixed position relative to the clutch 10. This may be used where the base 110 cannot protrude outside the clutch 10 and the clutch 10 has a rigid interior frame suitable for supporting the compression (in, for example, clutches 10 that include a snap clasp) or with any other type of clutch 10, including those with no rigid frame, or in any other suitable usage scenario.

The base 110 is preferably one of the above describe variations, but may alternatively be any other combination of the above described variations or any other suitable arrangement. Alternatively, the base 110 may also be of a set length.

The base 110 of the preferred embodiment may also include a fastener 114 to mount the base 110 to the clutch 10. The fastener 114 is preferably of a non-permanent type, allowing the base 110 to be attached and detached from a clutch 10. A non-permanent type fastener may also allow the base 110 to be transferred to and attached and detached from a second clutch 10. The fastener 114 is also preferably of a type that does not damage the clutch 10 and is preferably substantially invisible from the exterior of the clutch 10. The fastener 114 may be an adhesive that is relatively easily removed from the clutch 10 (for example, 3M Command adhesive), but may alternatively include a portion that remains attached to the clutch 10 (for example, Velcro fastener). The fastener 114 may also be a mechanical fastener such as a clip that clips onto a surface of the clutch 10. The fastener 114 may also be a magnetic type fastener. For example, a first magnet may be attached to the base 110 and a second magnet may be attached to the clutch 10 and the attractive force between the magnets mounts the base 110 to the clutch 10. However, any other suitable non-permanent type fastener may be used. The fastener 114 is preferably directly mounted to the base 110. To facilitate coupling the fastener 114 to the base 110, the geometry of the base 110 preferably includes at least one flat surface (for example, the “D” type cross section as mentioned above), however, any other suitable surface may be used. In the variation of the base 110 that includes a colored sleeve to match the clutch 10, the fastener 114 may be coupled directly to the colored sleeve. Alternatively, the fastener 114 may be of the permanent type, for example, glue. However, the fastener 114 may be of any other suitable type.

The base attachment 122 of the strap 120 preferably includes a hook or a clasp that couples to the attachment point of the base 110. The base attachment 122 preferably allows for non-permanent coupling of the strap 120 to the base 110, allowing the strap 120 to be removed by the user. However, the base attachment 122 may couple to the attachment point of the base 110 in any other suitable way, for example, a magnetic fastener, and/or a non-permanent adhesive. The base attachment 122 may also permanently couple the strap 120 to the base 110.

The purse conversion device 100 is preferably provided to the user in a set that includes the base 110 and the strap 120. The set may also include the fastener 114. Additionally, the set may include a plurality of straps 120 of a variety of types to allow the user to “mix and match” with a variety of clutch 10 types. The set may also include a plurality of bases no that may each be used with a different clutch 10, for example, in variations where the fastener 114 is permanent, and/or where the base 110 is of a set length. A plurality of bases 110 may also be provided so that the user may have a plurality to use with a plurality of clutches 10 or may be provided of a variety of colors to allow the user to “mix and match.” The set may also be any suitable combination of the above. For example, the set may include only the base 110 and a fastener 114, only the base 110, only a strap 120, or only a plurality of straps 120.

As a person skilled in the art will recognize from the previous detailed description and from the figures and claims, modifications and changes can be made to the preferred embodiments of the invention without departing from the scope of this invention defined in the following claims.

I claim:

1. A device for temporarily equipping a bag with a strap comprising:
a rod including two ends;
a strap having a first end attached at one end of the rod, and having a second end attached at another end of the rod; and
an affixation apparatus that temporarily affixes the rod to the bag.

2. The device of claim 1, wherein the strap includes a chain of links.

3. The device of claim 1, wherein the length of the rod is adjustable.

4. The device of claim 3, wherein the rod includes a plurality of telescoping sections.

5. The device of claim 4, wherein the telescoping sections are cylindrical.

6. The device of claim 3, wherein the rod includes two sections, the first section having a track, and the second section traveling along the track.

7. The device of claim 1, wherein the affixation apparatus includes a clip that is attached to the rod and that is adapted to clip onto the bag.

8. The device of claim 7, wherein the affixation apparatus further includes a second clip, and wherein the clip is attached to the rod substantially near one end of the rod and the second clip is attached to the rod substantially near the other end of the rod, and wherein the clips each open in the direction of the center of the rod and clip onto opposite edges of the bag.

9. The device of claim 1, wherein the rod affixes to the bag detachably and non-destructively.

10. The device of claim 9, wherein the affixation apparatus includes a plurality of magnets.

11. The device of claim 9, wherein the affixation apparatus includes an adhesive material that adheres to the rod and to the bag.

12. The device of claim 9, wherein the length of the rod is adjustable.

13. The device of claim 12, wherein the affixation apparatus includes a compression spring mechanism that biases the two ends of the rod when the ends are forced inward.

14. The device of claim 13, wherein the compression spring mechanism includes a helical coil.

15. The device of claim 1, wherein the strap includes an attachment mechanism that removably attaches the first and second ends of the strap to the rod, wherein the attachment mechanism allows the strap to detach from the rod.

16. The device of claim 1, wherein the rod, when affixed to the bag, supports the shape of the bag and prevents the bag from deforming substantially.

17. A device for temporarily equipping a bag with a strap comprising:
a telescoping rod of adjustable length;
a strap having a first end attached at one end of the rod, and having a second end attached at another end of the rod; and
two clips that are attached to the rod near each of the two ends of the rod, with the clips opening in the direction of the center of the rod and that are adapted to clip onto the bag.

18. A device for temporarily equipping a bag with a strap comprising:
a telescoping rod of adjustable length;
a strap having a first end attached at one end of the rod, and having a second end attached at another end of the rod; and
a compression spring mechanism that biases the two ends of the rod when the ends are forced inward.

19. A method of temporarily equipping a bag with a strap comprising the steps of:
providing a rod and a strap, wherein the strap has two ends that are attached at either end of the rod; and
affixing the rod to the bag.

20. The method of claim 19, wherein the length of the rod is adjustable.

21. The method of claim 20, further comprising adjusting the length of the rod to approximately equal the width of the bag prior to affixing the rod to the bag.

22. The method of claim 20, further comprising biasing the two ends of the rod when the ends are forced inward, and inserting the rod in compression between opposing ends of the bag.

23. The method of claim 19, wherein the step of affixing the rod to the bag includes the steps of providing two clips, mounting the clips to the rod near the two ends of the rod, and clipping the clips onto the edges of the bag.

24. The method of claim 19, further including detaching a first strap from the rod and attaching a second strap to the rod.

25. The method of claim 19, further including detaching the rod from the bag.
